(19) United States
(12) Patent Application Publication
(10) Pub. No.: US 2010/0193406 A1
(43) Pub. Date: Aug. 5, 2010

(54) Equipment for use in the extraction of placer gold from gravel and sand deposits

(76) Inventors: Larry Allen Alderson, Robards, KY (US); Peggy I. Alderson, Robards, KY (US)

Correspondence Address: Larry Alderson, 15967 Hwy 136 East, Robards, KY, 42452, US

(21) Appl. No.: 12/657,265

(22) Filed: Jan. 15, 2010

Related U.S. Application Data
(60) Provisional application No. 61/206,728, filed on Feb. 4, 2009.

(51) Int. Cl. B03B 7/00

(52) U.S. Cl. 209/44

(57) ABSTRACT

A portable device for the separation of gold from other materials commonly found in placer deposits of gravel, sand, etc. Including an upper tray (72) into which is located a water spray assembly and placer materials classifier. This upper tray to be hinged to middle sluice tray (98), which has located on its bottom panel an expanded metal section (38) on top of a final mat (40) consisting of ribbed rubber matting or other suitable material, which has a series of groves, to be used as washable riffling device. Lower sluice tray (96) to be attached by hinging device to middle sluice tray (98) and locked into place by lower tray locks (48). Lower sluice tray to have laying on its bottom panel a continuation of final mat (40). This mat to be held in place by a riffle cage (36) containing a series of rigid riffles. Riffle cage (36) to be secured by hold down clamps (64). Expanded metal to be held in place by tab (42). Upper tray to be supported by sliding brace (43) and locking handles (94). Device to be supported by legs (68) and extenders (74). Water to be supplied by small pump to device through flexible hose connected to feed pipe (78). When not in use the device to be folded and compactable into small portable unit with storage of legs, mat, riffle cage and other removable accessories inside embodiment and secured by means of storage lids (30) and (90). Lid (90) to be secured by means of locks (48) and tabs (114). Device to be carried by handle (88).

### REFERENCE TO RELATED APPLICATIONS

This application claims the benefit of provisional patent application No. 61/206,728 filed Feb. 4, 2009 by the present inventors.

### FEDERALLY SPONSORED RESEARCH

Not Applicable

### SEQUENCE LISTING OR PROGRAM

Not Applicable

### BACKGROUND

1. Field

This application relates to the mining of precious metals, in particular gold.

2. Prior Art

Gold prospectors and miners typically travel to remote locations to locate rich deposits of gold bearing placer deposits. To reach these Locations requires a tremendous amount of effort on the part of the prospector. The prospector is usually limited in the amount of equipage that he is able to transport. With the exception of the basic gold pan, all the equipment traditionally needed to process these placer deposits has been extremely heavy and bulky. While a basic gold pan is very efficient, it is not able to process a very large amount of gold bearing sands and gravel. Therefore, the tool of choice to accomplish a reasonable rate of recovery has been the gold sluice or some variation of it. Efforts have been made in the past to reduce the physical requirements needed to transport the needed sluice or its variation, usually at the forfeit of usability or function. U.S. Pat. No. Des. 377,182 issued Jan. 7, 1997 to Simpson, shows a basic sluice. While small and functional it is not very versatile, requiring a flowing natural water source in order to function. Its reduced size also limits the amount of raw material it is able to process. A larger more efficient transportable sluice is shown in U.S. Pat. No. 3,799,415 issued Mar. 26, 1974 to Tidd. While greatly more efficient, its size and carrying method require too much effort to transport. Another piece of equipment favored by prospectors is an enhanced version of the sluice commonly called a high banker. It derives its name by the fact that it can be used out and away from the stream flow. This does make it much more versatile than a basic sluice but is again more difficult to transport. In order to function it requires a source of pressurized water. This source is usually obtained by using a gas or electric pump with its intake source a stream or an area of ponded water. U.S. Pat. No. 7,012,209 B2, issued Mar. 14, 2006 to Loewen, shows an apparatus using this method. Transportation by manual methods is extremely cumbersome and not very desirable. U.S. Pat. No. 4,525,270 issued Jun. 25, 1985 to McCann, depicts an interesting apparatus but due to its small size and cumbersome handling and transporting characteristics leaves much to be desired by the prospector. Having to empty and clean the filter bag system is a further interference to efficiency. U.S. Pat. No. 4,319,985 issued Mar. 16, 1982 to Hibbard, is a more efficient system but is lacking the portability desired by the prospector. All the aforementioned devices also lacks the flexibility needed to have a diverse, fully functional piece of prospecting equipment. They lack the ability to process placer gravel and sand by more than one method. In addition to the sluice and its variant, previously referred to as a high banker, another piece of prospecting equipment is available commonly referred to as a suction dredge. This apparatus uses water or air forced down a hose to the nozzle under pressure. Its function is to generate a negative pressure in the nozzle whereby in addition to the pressurized air/water stream the negative pressure in the nozzle sucks in through the nozzle tip additional water and a quantity of sand and gravel. These are then carried to a separating device, called a sluice. U.S. Pat. No. 1,653,027, issued Dec. 20, 1927 to Ward, demonstrates this nozzle This nozzle is designed for large commercial mining ventures with no thought to the small prospector. None of the devices referred to have the dual function and ability to accept and process both placer sand and gravel by either a slurry as provided by the suction nozzle system and also manually by hand feeding with a shovel or a variant.

### ADVANTAGES

My invention addresses all the shortcomings of the previous designs. Not only is it highly portable it is a fully functional piece of equipment. It has the ability to process placer materials whether manually fed by hand or by a pressurized slurry system.

### SUMMARY OF THE INVENTION

This application is for a lightweight, compact piece of mining equipment that allows the prospector great flexibility and portability while still providing excellent heavy metals and minerals recovery. It is a gold concentrator that removes gold from suspension, utilizing a slurry of sand and water provided by several means. While gold concentrators of different designs have been in circulation for many years they have tended to be rather large, bulky and hard to transport. With this in mind the object of this embodiment has been to provide the prospector with a very compact piece of mining equipment that is also very light and easy to set up without sacrificing any features of much larger units. To optimize recovery of the gold particles, gold bearing placer materials are introduced into the upper portion of the invention where they are mixed with water thereby creating a slurry. The slurry passes through a removable, interchangeable classifier, thereby removing larger waste rock and gravel. The slurry then falls upon a deflector pan or under chute which carries it by means of gravity, and its liquid state, to the upper portion of the processing sluice or tray. The sluice area is composed of bi-fold trays that hinge on each other whereby its overall length can be reduced for transportation and expanded for use. With this arrangement no sacrifice of recovery area is made. If the embodiment is used in conventional mode then a small pump, gas or low voltage electric, is placed in a water supply. This water supply may be a natural body of water or a containment vessel. With this in mind, my embodiment is small enough to be placed within a small storage, transportation container. This storage container can then be used as a recirculating water containment vessel. This ability is of great benefit to prospectors working in arid areas where a natural water source is not available. Water, either from a natural or artificial source is pumped, by means of a small flexible hose, to the spray piping arrangement located in the upper tray portion of the invention. This spray piping system is constructed so that water under pressure, provided by the pump is sprayed, out across the sand and gravel placer materials, through a plurality of small holes directed at the placer materials receiving area on top of the classifier, thereby creating the aforementioned slurry. The waste material then slides off the lower end of the classifier and is no longer an area of concern. After being diverted to the upper end of the lower sluice area the slurry then passes over the expanded metal section. This section consist of raised expanded metal which in cross section creates a series of small riffles. The purpose of a riffle is to create an area of low pressure, located immediately behind the riffle, into which gold particles as well as other heavy materials, mostly hematite and magnetite, commonly referred to as black sand, become trapped. Some heavier gemstones are also collected in the low pressure areas commonly referred to as eddies. Eddies are created when a protrusion is placed into a moving flow of water, creating high pressure on the upstream side and low pressure on the down stream side. The aforementioned expanded metal section is placed on top of a final mat consisting of any number of materials. The most common are ribbed indoor outdoor carpet, v-ribbed rubber matting or an extruded rubber fiber matting commonly referred to as “miners moss”. The purpose of the final mat is to provide additional small riffles by means of a series of small groves which run perpendicular to the flow of the slurry. After leaving the expanded metal section the slurry then passes over a riffle cage consisting of a plurality of riffles which run perpendicular to the slurry flow. Again, the riffle cage is installed on top of the final mat and secured in place. Since the recovery rate of the invention is dependant on water flow the utilization of adjustable legs is provided. This allows for maximum adjustment of the water flow which must be carefully regulated for maximum recovery. In lieu of a spray bar method of creating the slurry, an adapter mechanism is provided for the use of an underwater dredge system. This system sucks raw material from the bottom of the prospecting body of water carrying with it the placer materials containing the black sand and gold particles and sprays it across the upper tray classifier

### DRAWINGS-FIGURES

Dwg. 1/17 FIG. 1 Shows the embodiment in its storage/transportation configuration.

FIG. 2 Shows the embodiment set up and ready to use.

Dwg. 2/17 FIG. 3 Shows the embodiment in use by being manually fed with placer sand/gravel. Water is supplied from a natural water source near the embodiment.

Dwg. 3/17 FIG. 4 Shows the embodiment in use by being fed with a sand/gravel slurry by mean of an underwater dredge system.

Dwg. 4/17 FIG. 11 Shows one of two storage/transportation lids used by the embodiment.

Dwg. 5/17 FIG. 6 Shows the embodiment in an exploded view illustrating some of the major components.

Dwg. 6/17 FIG. 7 Shows a portion of the embodiment, referred to as the middle tray, and all of its components.

Dwg. 7/17 FIG. 8 Shows the embodiment in top or plan view. Also depicted are some of the components and their positions on the embodiment.

Dwg. 8/17 FIG. 9 Shows a section view derived from the plan view in FIG. 8 on Dwg. 7/17. Also shown are some parts and their positions on the embodiment.

Dwg. 9/17 FIG. 5 Shows the embodiment in use by being manually fed with placer sand and gravel. Water is supplied by a recirculating method utilizing a transportation container.

Dwg. 10/17 FIG. 10 Shows the riffle cage and componets

Dwg. 11/17 FIG. 14 Shows the embodiment in travel/storage position.

FIG. 15 Shows the embodiment being set up with the lower tray being folded out and secured.

FIG. 16 Shows the embodiment setup complete with the upper tray raised and secured as well as the legs and rear leg extenders in position.

Dwg. 12/17 FIG. 12 Shows the upper tray of the embodiment and its components.

Dwg. 13/17 FIG. 20 Shows the spray bar in exploded view as well as its components.

Dwg. 14/17 FIG. 13 Shows the embodiment in storage, travel mode as well as the accessories and their locations when the embodiment is in storage/travel and storage mode.

Dwg. 15/17 FIG. 11 Shows the embodiment with optional shoulder straps for backpacking.

Dwg. 16/17 FIG. 21-A Shows a sectional view derived from FIG. 9 on

Dwg. 8/17. This section shows a riffle as well as indoor outdoor carpet being used as a collecting medium

FIG. 21-B Shows a sectional view derived from FIG. 9 on Dwg. 8/17. This section shows a riffle as well as ribbed rubber matting being used as a collecting medium

Dwg. 17/17 FIG. 22 Shows the larger storage lid used in storage/travel mode.

### REFERENCE NUMERALS

30 Small lid 58 Upper tray end plate
32 Lid strap 60 Leg locking screw
34 Lid strap bracket 62 Closure tab
36 Riffle cage 64 Riffle hold down clamp
38 Expanded metal section 65 90 degree ell.
40 Final mat 66 Spray pipe
42 Expanded metal section hold down tab 67 Tee
43 Sliding brace 68 Leg
44 Upper tray pivot bracket 69 Cap
46 Middle tray end plate 70 Under chute
48 Lower tray lock 72 Upper tray
50 Leg socket 74 Leg extender
52 Closure clasp 76 Leg extender pin
54 Lower and middle tray hinge 78 Spray piping feed pipe
56 Upper tray classifier 80 Upper tray dredge feed plate
82 Dredge discharge hose adapter 104 Storage container
84 Dredge pipe adapter lock ring 106 Water level
86 Spray piping feed hose 108 Gravel waste tailings
88 Carry handle 110 Sand/gravel placer materials
90 Storage lid 112 Water/sand slurry
92 Low voltage pump 114 Latching tabs
94 Sliding brace locking handle 116 Intake screen
96 Lower tray 118 Intake hose
98 Middle tray 120 Pressure pump
99 Retaining lip 122 Pressure hose
100 Riffle cage hold down tab 124 Dredge suction nozzle
102 Shoulder straps 126 Dredge discharge hose
128 Retaining rail

### Detailed Description FIG. 1

FIG. 1 of the embodiment, as shown on Dwg. 1/17, shows the embodiment in its carrying/storage configuration. All accessories have been stowed inside, and covers in place. The prospector is now ready to pick up the embodiment and transport or store the equipment.

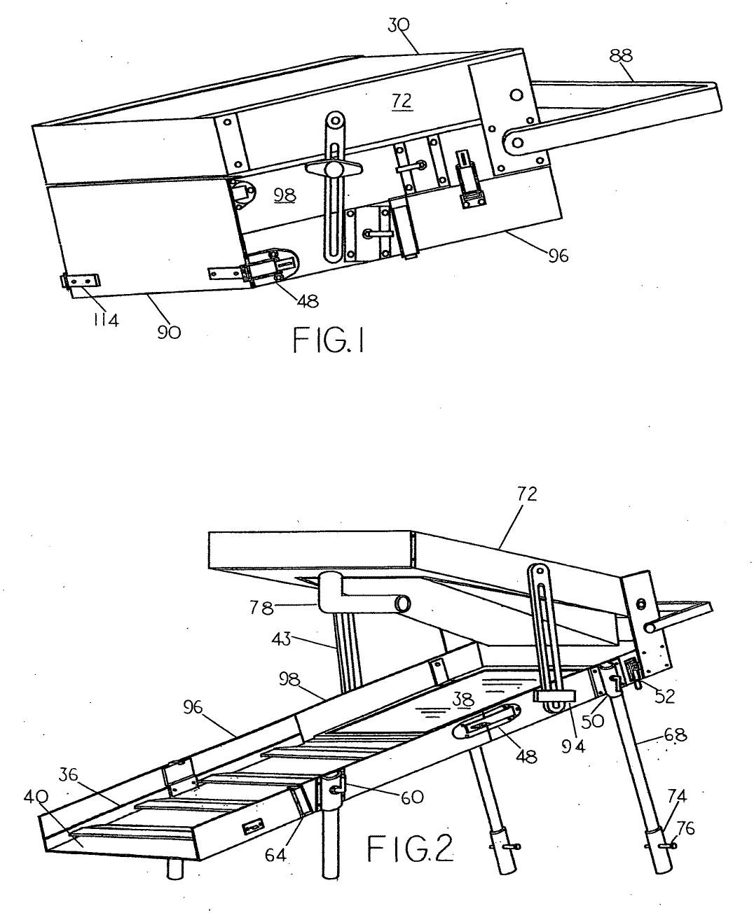

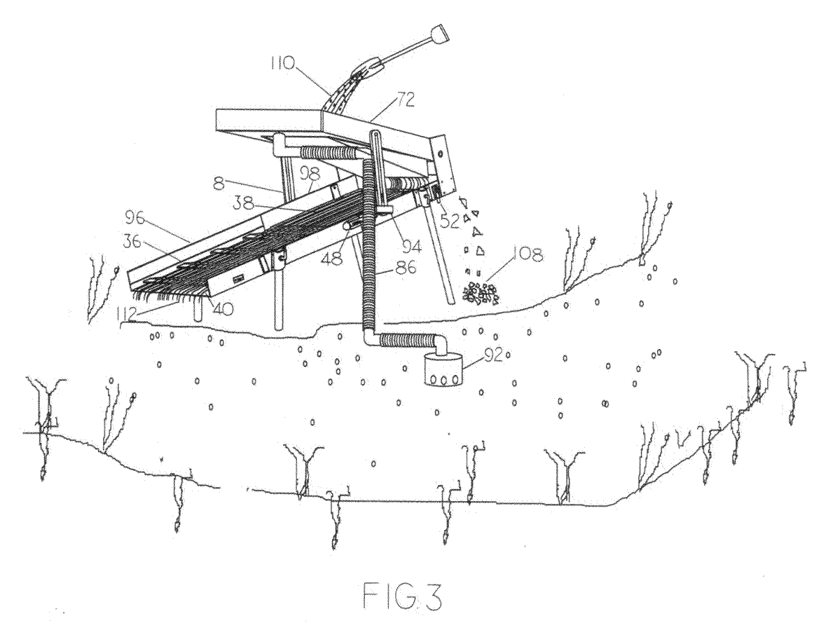

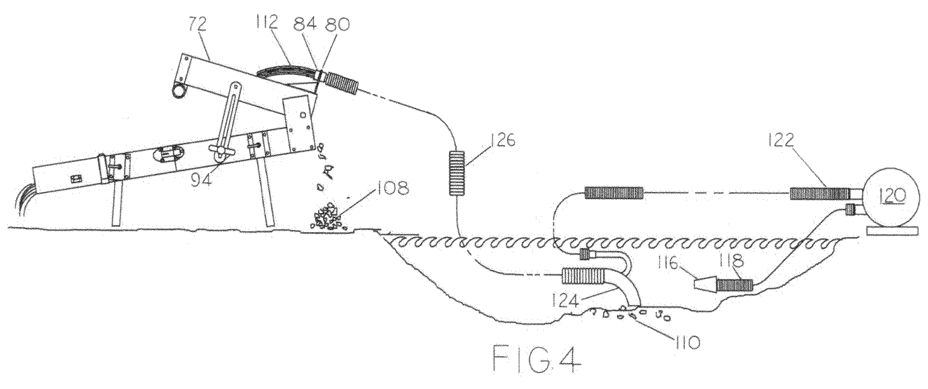

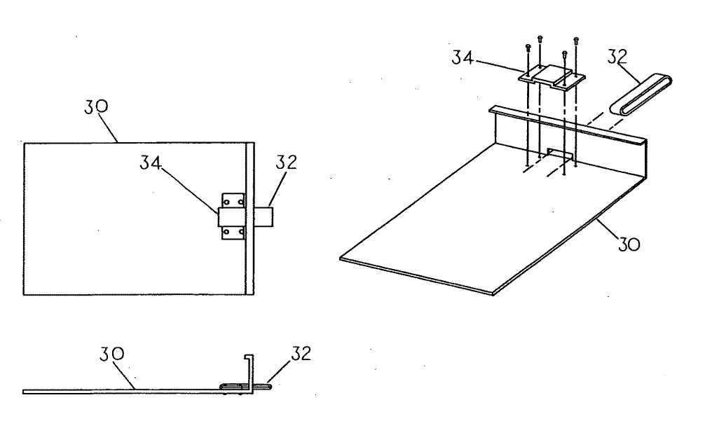

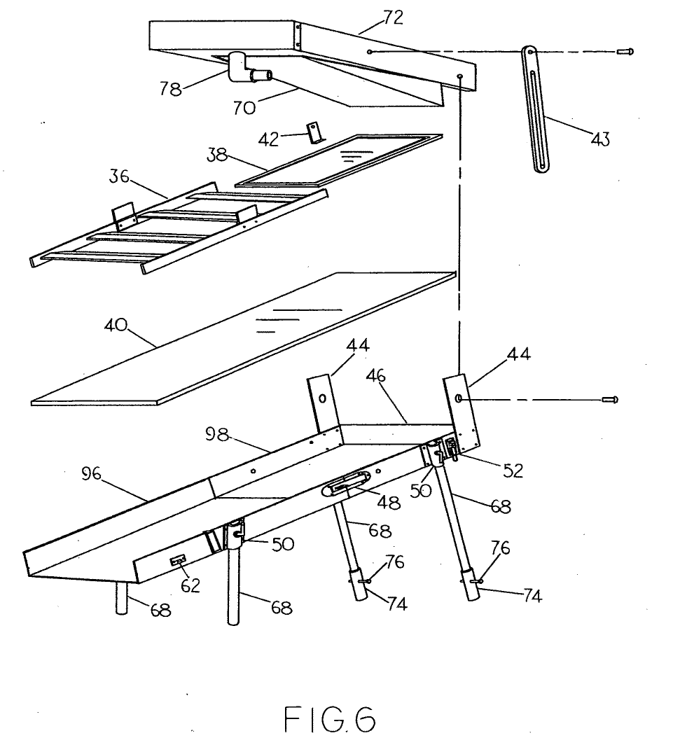

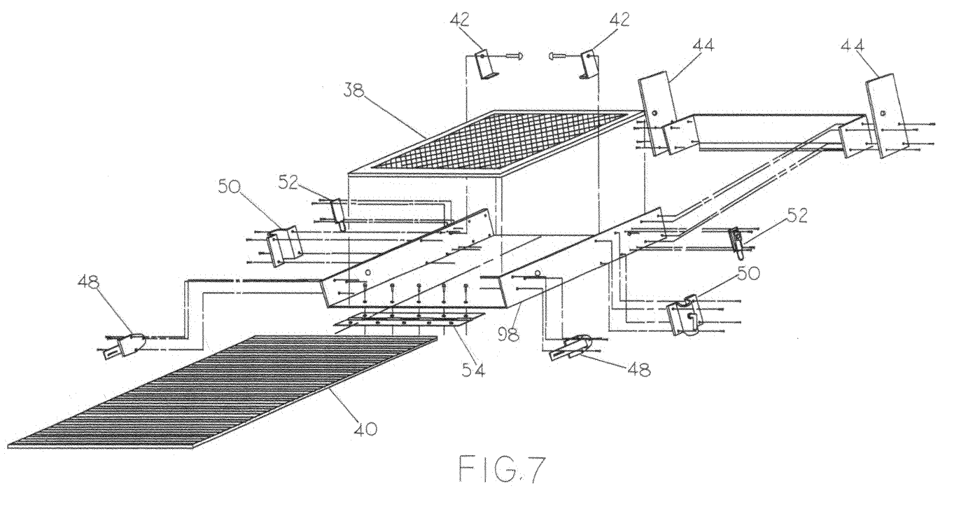

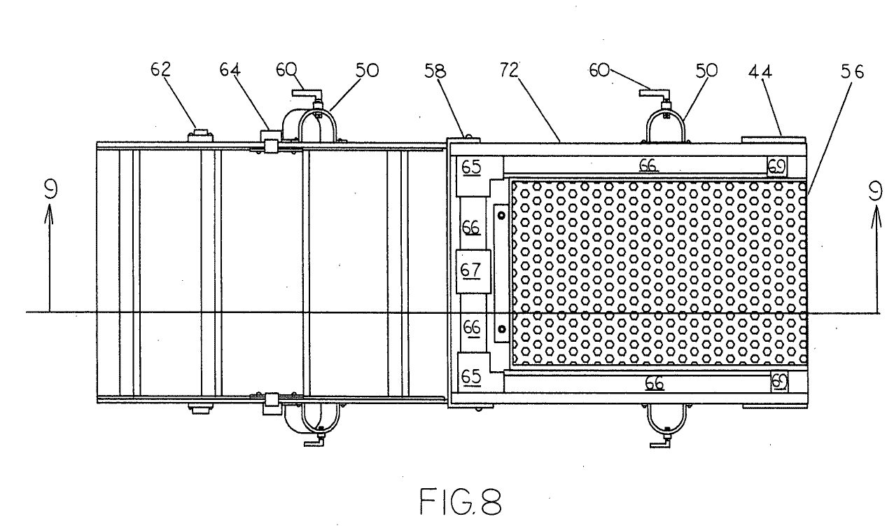

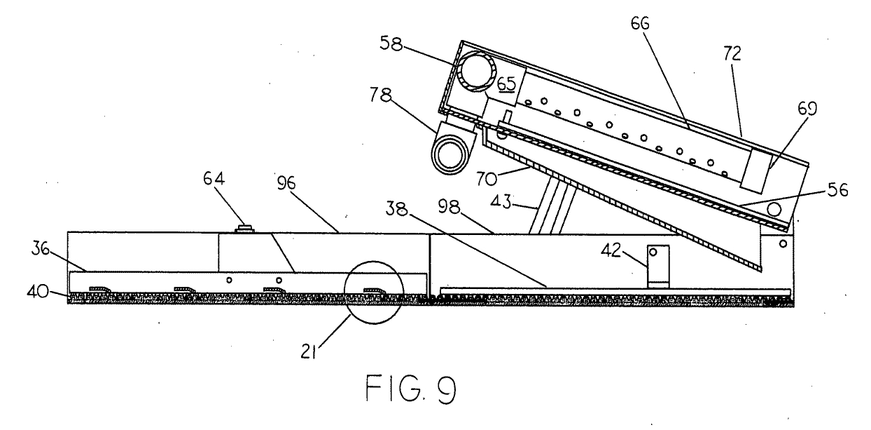

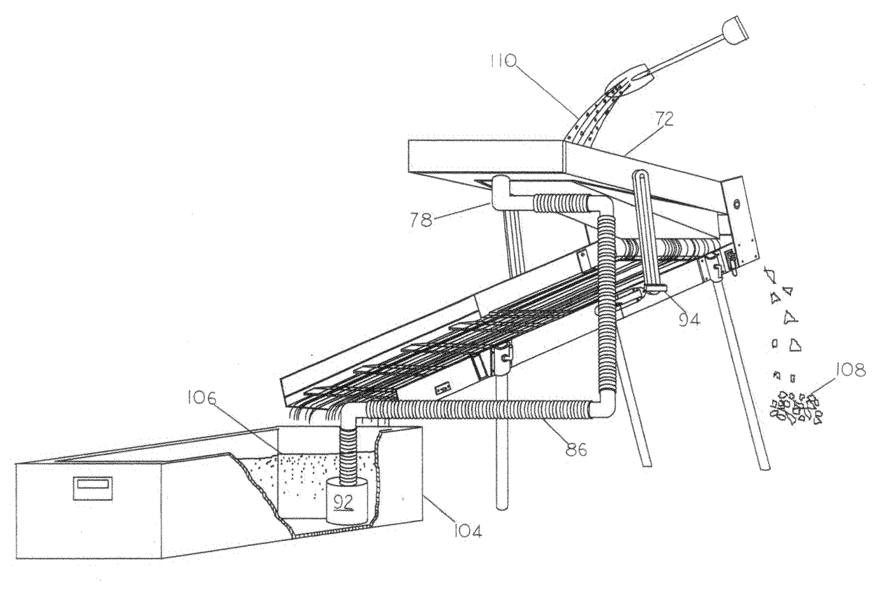

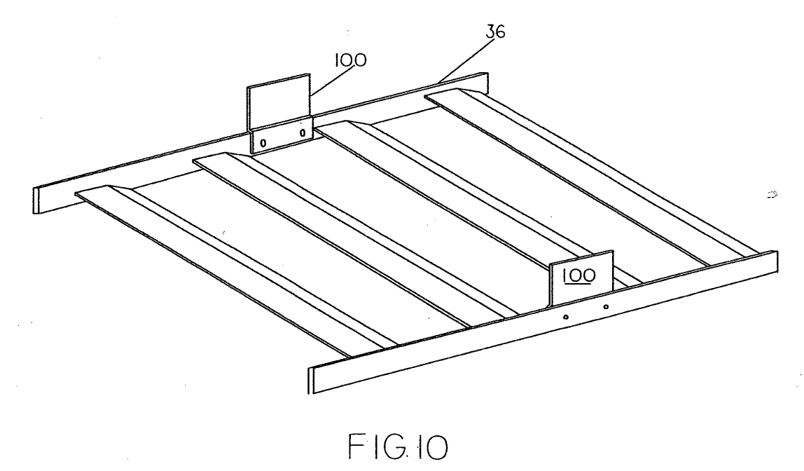

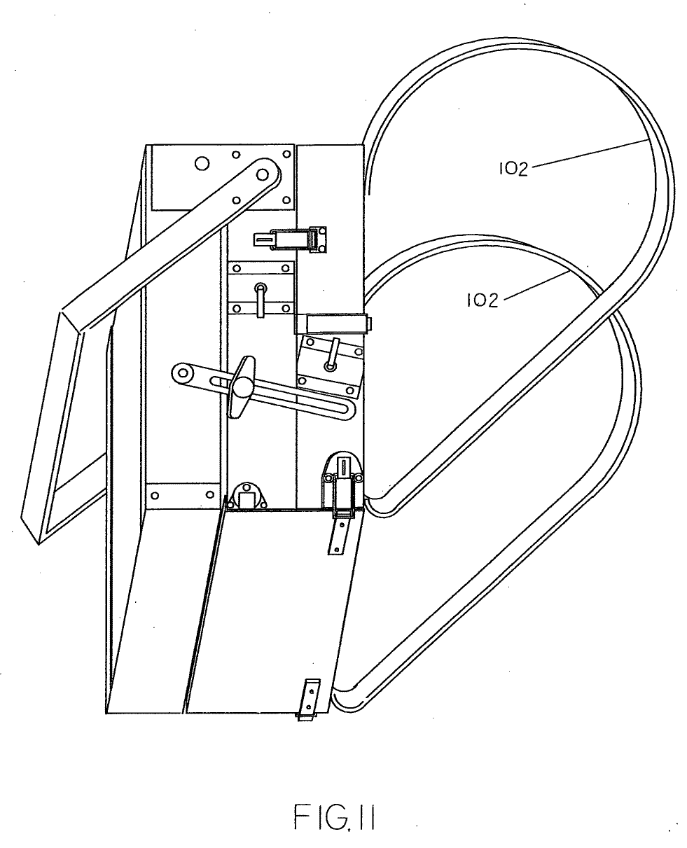

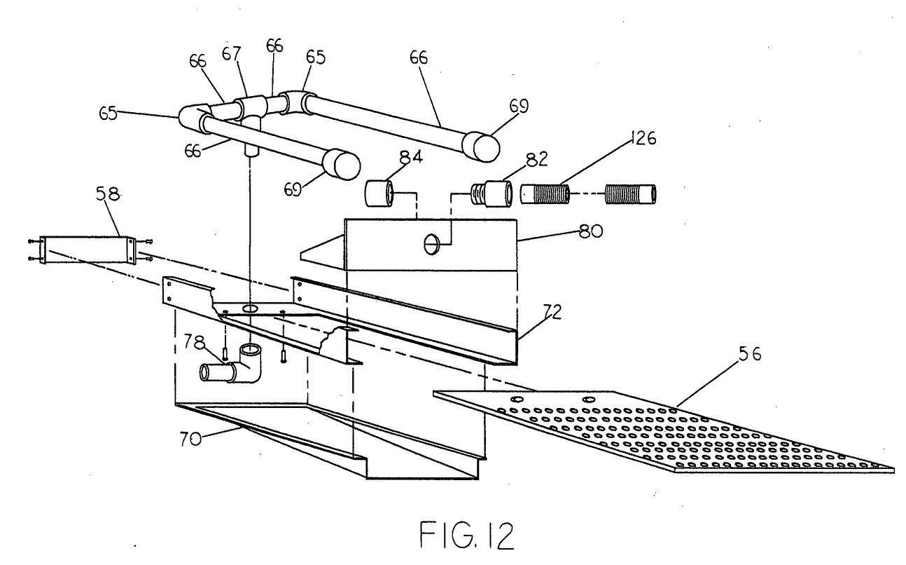

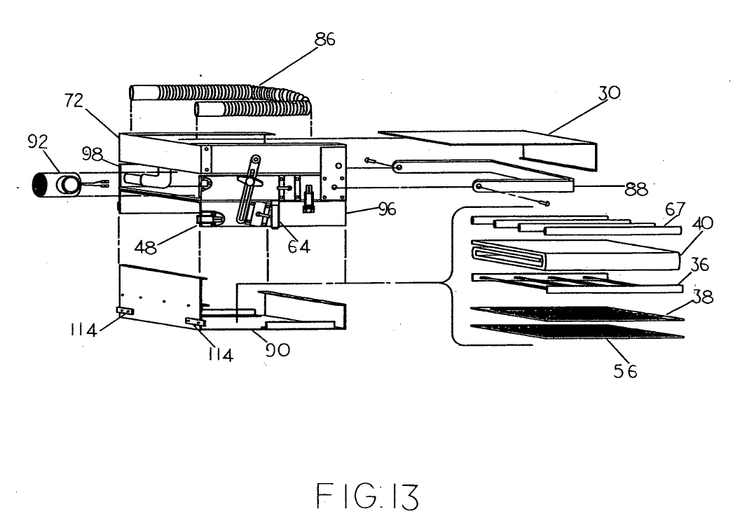

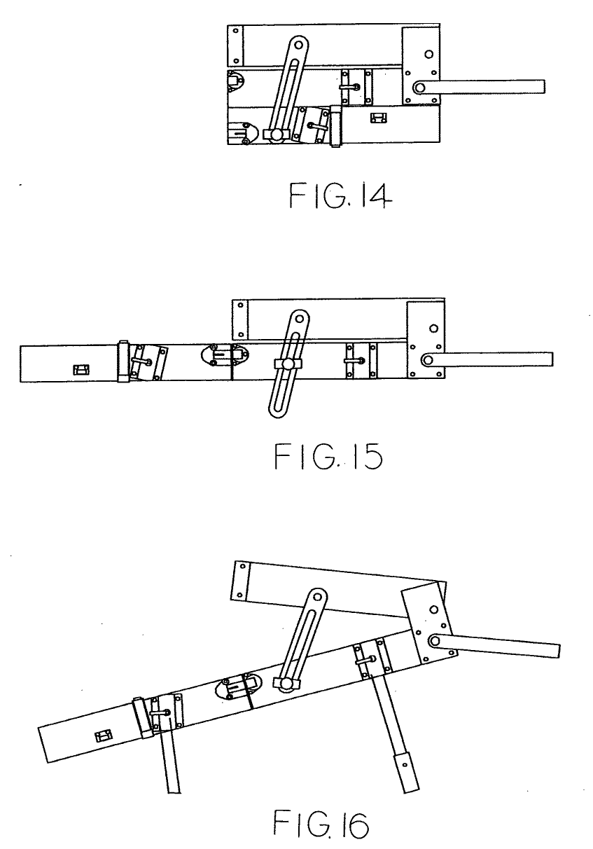

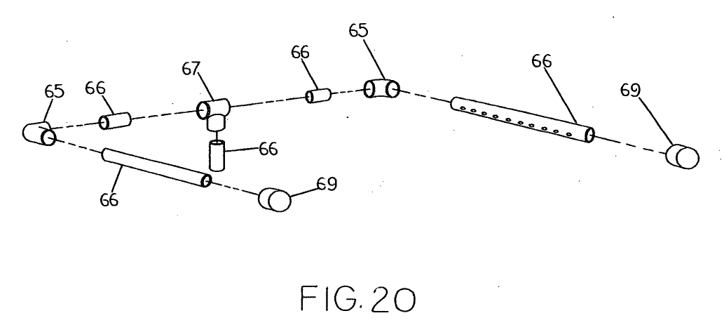

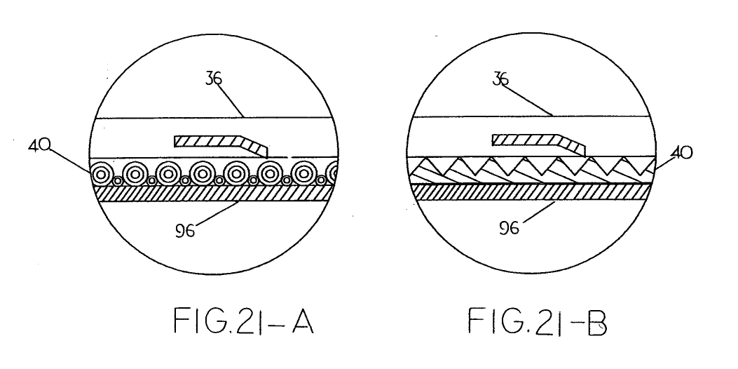

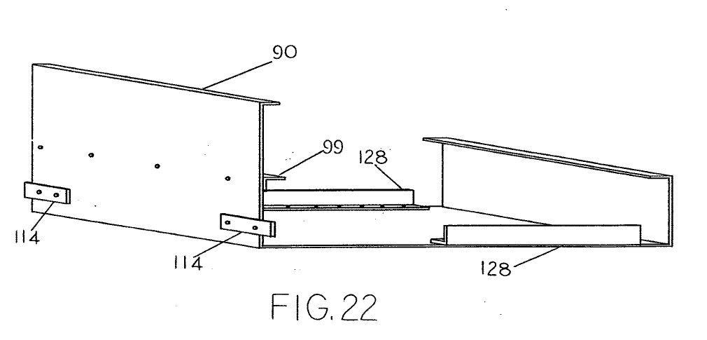

### Detailed Description FIG. 2

FIG. 2 of the embodiment, as shown on Dwg. 1/17 shows the embodiment in a configuration for use with the exception of the water source, which is not shown.

### Detailed Description FIG. 3

FIG. 3 as shown on DWG. 2/17 shows the embodiment set up and ready for general use. Upper tray 72 has been raised and sliding braces 8 have been locked in place by sliding brace lock handle 94. Lower tray 96 has been released from closure clasp 52 and rotated and locked in position by the lower tray lock 48. Final mat 40 is in place as are expanded metal section 38 and riffle cage 36. Sand/gravel placer materials 110 are being manually fed into the upper tray 72. They are being processed by water supplied, through the spray piping hose 86, by a pump 92 in a natural source of water. Water/sand slurry 112 with gold/gem values are being carried through and down the recovery area consisting of the middle tray 98, lower tray 96, expanded metal section 38, riffle cage 36, and final mat 40. Gravel waste tailings 108 are shown coming off the upper tray 72

### Detailed Description FIG. 4

FIG. 4 as shown on Dwg. 3/17 shows one method of using the embodiment. It involves the use of dredge suction nozzle 124 in the processing of sand/gravel placer materials 110. In order for this system to work an external source of pressurized water is required. Pressure pump 120, which is a hand transportable small horsepower water pump fulfills this need. It provides pressurized water to the suction nozzle 124 by means of a small diameter flexible pressure hose 122.

This water is supplied to the pump through intake screen 116 and intake hose 118. These have been positioned in a natural body of water. In this instance the same body of water that contains the sand/gravel placer materials 110. Since the suction nozzle 124 is constructed to handle a larger capacity of water than the pump 120 and pressure hose 122 are providing and also since this water is under pressure, it creates a negative vacuum inside the nozzle. Because of this vacuum the prospector is able to introduce the tip of the nozzle into the placer sand and gravel and generate a sand/gravel slurry 112 which is forced up the discharge hose 126. This sand/gravel slurry 112 is then discharged into the upper tray 72 for processing. The dredge discharge hose 126 is attached to the lower end of the upper tray 72 by means of a removable upper tray dredge feed plate 80, dredge discharge hose adapter 82 and dredge discharge hose adapter lock ring 84. The sand/gravel placer materials 110 are processed in the normal manner. The gravel waste tailings 108 are discharged from the rear of the upper tray 72 and the water/sand slurry 112 are processed through the lower sluice area consisting of the middle tray 98, lower tray 96, expanded metal section 38, riffle cage 36 and final mat 40 as shown in FIG. 3. Use of the spray piping assembly is not utilized when the embodiment is used in suction dredge mode.

With the exception of the use of my embodiment in the separation of the sand and gravel from the gold particles in liquid suspension, this mode of operation is to be considered Prior Art. This is based on U.S. Pat. No. 1,653,027 to Ward dated Dec. 20, 1927.

### Detailed Description FIG. 11

FIG. 11 on Dwg. 4/17 shows the small lid 30 and its attached components, lid strap 32 and lid strap bracket 34. The purpose of this lid is to provide a convenient cover and retaining mechanism whereby loose accessories, in particular the spray piping hose 86, are stored while in storage transportation configuration.

### Detailed Description FIG. 6

FIG. 6 shows some components to make up the embodiment. This is accomplished in exploded or expanded view for clarity. Lower tray 96 has been released from its closure clasp 52 and rotated into position for use. Lower tray locks 48 have been engaged securing lower tray 96 to middle tray 98. Legs 68 are installed into leg sockets 50. Leg extenders 74 have been installed on rear legs 68 and leg extender pin 76 has been inserted. A retaining cable or chain, not shown, is used to keep the retainer pin attached to the leg extender, to prevent loss. Final mat 40 is ready for installation into lower tray 96 and middle Tray 98. This is followed by the expanded metal section 38 which is installed into middle tray 98 and secured by hold down tab 42. Riffle cage 36 is then installed into the lower tray 96 and held in place by riffle cage hold down clamps 64. Upper tray 72 is raised into an inclined position and held in place by sliding brace 43. Raising upper tray 72 exposes spray piping feed pipe 78 which is now ready for connection to a water supply source. Some components are used in plurality as detailed in successive Figures.

### Detailed Description FIG. 7

FIG. 7 Dwg. 6 illustrates middle tray 98 and its components. Middle tray end plate 46 and upper tray pivot brackets are attached to middle tray 98 by means of a plurality of fasteners through a plurality of holes on common centers thereby providing a secure support for upper tray 72, not shown. Lower tray locks 48, leg sockets 50 and closure clasp 52 are all attached to middle tray 98 in positions indicated. Lower tray 96, not shown, is provided by a means of pivot by lower and middle tray hinge 54. These attachments are accomplished by use of fasteners inserted through the attachments and holes provided in the middle tray 98. Also shown in this view is a portion of final mat 40 ready for installing into the bottom of middle tray 98 followed by the expanded metal 38. The expanded metal 38 is secured in place by expanded metal hold down tabs 42, which are provided a single off center fastener, thereby providing a pivot point enabling it to rotate and lock the expanded metal section 38 and final mat 40 in place. Expanded metal section 38 and final mat 40 are placed one on top of the other thereby receiving common pressure from hold down tabs 42. Lower tray locks 48, leg sockets 50, closure clasps 52, upper tray pivot bracket 44 and expanded metal section hold down tabs 42 are common to both sides of middle tray 98.

### Detailed Description FIG. 8

FIG. 8 shows the embodiment in plan or top view. Closure tabs 62, riffle hold down clamps 64, leg sockets 50, leg locking screws 60 and upper tray pivot brackets 44 are in place. These parts are used in plurality typical to both sides of the embodiment. Also shown is the upper tray 72 with the upper tray end plate 58. The upper classifier 56 is in place as is the spray piping assembly consisting of caps 69, spray pipes 66, tee 67 and 90 degree ells 65. Lastly, shown is a section cut labeled 9 which will be shown on in FIG. 9 Dwg 8/17.

### Detailed Description FIG. 9

FIG. 9 Dwg. 8/17 shows section view taken from FIG. 8 Dwg. 7/17. Shown in this section are the lower tray 96, middle tray 98 as well as upper tray 72, which has been raised to an inclined position. The section also shows the riffle cage 36 held in place by riffle cage hold down clamp 64. Expanded metal section 38 is held in place by expanded metal section hold down tab 42. 36 and 38 are placed on top of final mat 40 so that when secured they hold final mat 40 in place. Upper tray 72 is shown in position supported by sliding brace 43. Under chute 70 has been attached with fasteners, not shown, to the bottom of upper tray 72. Upper tray end plate 58 has been attached to upper tray 72. Water spray piping assembly, consisting of spray pipe 66, cap 69, 90 degree ell 65 and tee 67 are in place. Spray piping feed pipe is also in place. Removable classifier 56 is in position over the cut out in upper tray 72. FIG. 21 has been circled which will show the riffle, and choice of final mat 40.

### Detailed Description FIG. 5

FIG. 5 DWG 9/17 shows the embodiment set up for use in recirculating mode. The incline of the upper tray 72 is adjusted by raising and lowering the tray and then tightening sliding brace locking handle 94. A storage container 104 has been positioned below the discharge or lower end of lower tray 96. The interior of the storage container 104 has been filled with water indicated by water level 106. Pump 92 has been positioned in the storage container 92 below water level 104. A section of the side wall of storage container 104 has been removed for clarity. A flexible spray piping hose 86 runs between pump 92 and spray feed pipe 78. Sand/gravel placer material 110 is being loaded into upper tray 72 for processing. Gravel waste tailings 108 are shown being discharged from upper tray 72.

### Detailed Description FIG. 10

FIG. 10 DWG. 10/17 shows riffle cage 36 with both riffle cage hold down tabs 100.

### Detailed Description FIG. 14

FIG. 14 DWG. 11/17 Shows the embodiment in storage/travel mode.

### Detailed Description FIG. 15

FIG. 15 DWG. 11/17 shows the embodiment in the process of being set up for operation.

### Detailed Description FIG. 16

FIG. 16 DWG. 11/17 shows the embodiment ready for use.

### Detailed Description FIG. 12

FIG. 12 DWG 12/17 shows the upper tray 72 and its components. Under chute 70 is permanently attached to the underside of upper tray 72. Upper tray end plate 58 is attached to the upper end of upper tray 72. Spray piping assembly, consisting of spray pipes 66, end caps 69, 90 degree ells 65 and tee 67 are permanently assembled and installed into upper tray 72. Spray feed pipe 78 is installed below and at 90 degrees to the longitudinal line of the upper tray 72. Upper tray 72 is shown with its cut out indicated, over which removable upper classifier 56 is installed. The purpose of the cut out is to allow for passage of the water/sand slurry when placer materials are placed upon upper classifier 56. This slurry passes through the classifier 56 and onto under chute 70 for transfer to the upper end of the middle tray 98, not shown. Shown is removable upper tray dredge plate 80 as well as dredge plate pipe adapter 82 dredge plate adapter lock ring 84 as well as dredge discharge hose 126.

### Detailed Description FIG. 20

FIG. 20, DWG. 13/17 shows the spray piping assembly consisting of end caps 69, spray pipes 66, 90 degree ells 65 and tee 67.

### Detailed Description FIG. 13

FIG. 13 DWG 14/17 shows the embodiment exploded and expanded to show method of storage of different components. Storage lid 90 is ready to receive legs 21, leg extenders and pins, not shown, final mat 40, which has been folded, riffle cage 36, expanded metal section 38 and upper classifier 56. Pump 92 is positioned in the space between upper tray 72 and middle tray 96. This space is made available when Upper tray 72 is lowered onto middle tray 98. Storage lid 90 it is then placed into position on the embodiment. When this is accomplished lower tray locks 48 engage latching tabs 114. Riffle hold down clamp 64 is also now available to be used to provide addition assistance in keeping storage lid 90 in position. When storage lid 90 is in position, it also provides closure panels for both open ends of lower tray 96, as well as, the one open end of middle tray 98. Spray pipe hose is now coiled and positioned inside the available space in the interior of upper tray 72. Storage lid 30 is then slid into position and the compaction of the embodiment is complete. Carry handle 88 is also shown being held in position by a single fastener on each side of the embodiment thereby providing a pivot point to allow movement of the handle, providing ease of handling.

### Detailed Description FIG. 11

FIG. 11, DWG. 15/17 shows the implementation of optional shoulder straps 102. These are to be used as additional carrying points if desired by the prospector.

### Detailed Description FIGS. 21-A & 21-B

FIG. 21-A DWG. 16/17 shows an enlarged view of a portion of the final mat 40, lower tray 96 and riffle cage 36. The purpose of this view is to demonstrate the purpose of some of the key components. FIG. 21-A shows the use of indoor/outdoor carpet as a final mat 40. FIG. 21-G shows the use of V-grooved rubber matting for a final mat 40. The purpose of these components will be described later.

### Detailed Description FIG. 22

FIG. 22, DWG. 17/17 shows the storage lid 90 and its components. These include latching tabs 114, retaining rails 128 and retaining lip 99. The purpose of 114, 128, and 99 are to secure the legs 67, final mat 40, riffle cage 36 3xpanded metal section 38 and upper tray classifier 56. When loaded into storage lid 90 in reverse order it brings into place the legs 67 as being last. By slipping one end of each leg under the formed edge on the shorter end wall of lid 90 and the other end under the storage lip 99 attached to the longer wall of lid 90, it thereby locks all components into position ready for transportation. Also part of this assembly, but not shown, is the use of a lid strap 32 and lid strap bracket 34 similar to that used in FIG. 11, Dwg. 4/17.

Operation

When the embodiment has been set up as shown in FIG. 5, DWG 9/17 and being ready to use, gold bearing placer materials are introduced into the upper portion of the embodiment 72 where they are mixed with water provided by either a remote low voltage pump or small gasoline pump 92 creating a slurry. An alternative source of gold bearing slurry can be introduced by means of a suction dredge arrangement as shown in FIG. 4, DWG 3/17. The slurry passes through a removable classifier 56, thereby removing larger waste rock and gravel which is discarded to the rear of upper tray 72. A variety of classifiers are to be made available, each with different size openings. The choice of the particular classifier is to be made by the prospector. Classifiers with larger openings will allow larger particles to enter the water/sand slurry 112. By chosing a classifier 56 which closely matches the size of the particles of gold to be processed the prospector can expect enhanced results. The slurry then falls upon a deflector pan or under chute 70 which carries it by means of gravity, and its liquid state, to the upper portion of the processing sluice or tray 98. The sluice area is composed of bi-fold trays 96 & 98 that hinge on each other whereby its overall length can be reduced for transportation and expanded for use. With this arrangement no sacrifice of recovery area is made. If the embodiment is used in conventional mode then a small low voltage pump or small gasoline powered pump 92 is placed in a water supply. This water supply may be a natural body of water or a containment vessel. With this in mind, this embodiment is small enough to be placed within a small storage container. The storage container can then be used as a recirculating water containment vessel as shown in FIG. 5 DWG. 9/17. This ability is of great benefit to prospectors working in arid areas where a natural water source is not available. Water, either from a natural or artificial source, is pumped by means of a small flexible hose 86, to the spray piping arrangement located in the upper tray 72 portion of the embodiment. This spray piping system is constructed so that water under pressure, provided by the pump 92 is sprayed, through a plurality of holes, out across the sand and gravel placer materials thereby creating the aforementioned slurry. The waste material then slides off the lower end of the classifier 56 and is no longer a concern. After being diverted to the upper end of the lower sluice area the slurry then passes over the expanded metal section 38. This section consist of raised expanded metal which in cross section creates a plurality of small riffles. This expanded metal section is held in place by means of hold down 42. The purpose of a riffle is to create an area of low pressure into which gold particles, as well as, other heavy materials, mostly hematite and magnetite, commonly referred to as black sand become trapped. Some heavier gemstones are also collected in the low pressure areas commonly referred to as eddies. Eddies are created when a protrusion is placed into a moving flow of water.

The aforementioned expanded metal section is placed on top of a final mat 40 consisting of any number of materials. The most common are indoor outdoor carpet, v-ribbed rubber matting or an extruded rubber fiber matting commonly referred to as “miners moss”. The purpose of the final mat 40 is to provide additional riffles by means of a plurality of small groves which run perpendicular to the flow of the slurry. After leaving the expanded metal section 38 the slurry then passes over a riffle cage 36 consisting of a plurality of riffles which run perpendicular to the slurry flow. Again, the riffle cage 36 is installed on top of the final mat 40 and secured in place with riffle hold down clamps 64. Since the recovery rate of the embodiment is dependant on water flow the utilization of adjustable legs 68, leg extenders 74 and extender retaining pin 76 are provided. This allows for maximum adjustment of the water flow which must be carefully regulated for maximum recovery. Final recovery of the gold particles and black sand is accomplished by removing the final mat 40 and washing it in a separate water filled container. The sand and gold particles are then separated in a gold pan.

Removable accessories are stored inside the embodiment as shown in FIG. 13, DWG. 14/17. FIG. 13 DWG 14/17 shows the embodiment exploded and expanded to show method of storage of different components. Storage lid 90 is ready to receive legs 21, final mat 40, which has been folded, riffle cage 36, expanded metal section 38 and upper classifier 56. Pump 92 is positioned in the space between upper tray 72 and middle tray 96. This space is made available when Upper tray 72 is lowered onto middle tray 98. Storage lid 90 it is then placed into position on the embodiment. When this is accomplished, lower tray locks 48 engage latching tabs 114. Riffle hold down clamp 64 is also now available to be used to provide additional assistance in keeping storage lid 90 in position. When storage lid 90 is in position it also provides thereby closure panels for both open ends of lower tray 96, as well as, the one open end of middle tray 98. Spray pipe hose 86 is now coiled and positioned, inside the available space in the interior of upper tray 72. Storage lid 30 is then slid into position and the compaction of the embodiment is complete. Carry handle 88 is also shown being held in position by a single fastener on each side of the embodiment thereby providing a pivot point to allow movement of the handle, providing ease of handling.

### CONCLUSION, RAMIFICATIONS, AND SCOPE

The reader will see that the embodiment of the present invention enables a gold prospector to transport, to the locations of the placer gold materials, a compact, fully functional tool for the separation of gold particles from waste sand and gravel.

The wide disparity between the specific gravity of gold at 19.3 and the specific gravity of the waste material at 2.0 creates the opportunity for rapid separation. The embodiment described herein excels at taking advantage of this disparity by means of riffles and other devices in this separation.

Since obvious changes may be made in the specific embodiment of the invention described herein, it is indicated that all matter contained herein is intended as illustrative and not limited in scope. For example the embodiment shown herein is constructed utilizing lightweight metal, i.e. aluminum. Other methods of construction are also possibilities, such as plastic and etc. Some of the attachments may be molded or welded onto the embodiment in lieu of using fasteners. The proportions of different components may be changed and methods of attachment may be altered. Thus the scope of the invention should be determined by the appended claims and their legal equivalents, rather than just by the examples given.

What I claim and desire to secure by letters of patent of the United States is:

1. The novelty of a gold prospecting invention that encompasses numerous features for the efficient separation of gold particles from gold bearing placer sand and gravel. This to be accomplished with a device that is highly portable and compact so as to reduce the difficulty in transporting the device to the prospecting site. This is accomplished by a series of hinged sections, with vertical walls, each containing different components for the efficient separation of gold particles from waste materials. The upper tray section, raised and locked, to an inclined position to accomplish initial separation by means of a wash system and classifier. A pressurized stream of water, obtained from a small pump, is directed at the placer materials placed upon the classifier. The larger waste materials are ejected allowing the finer materials to proceed through the classifier to the lower hinged and locked sluice trays by means of an under chute which directs the resulting slurry from the previous step to proceed to the upper extremity of these sluice trays. The slurry then passes over a series of different riffling components, I.e. an expanded metal section, riffle cage and a final mat I.e. indoor outdoor carpet or other suitable material, further separating the gold from waste materials. Riffling devices are removable so that final cleaning out and separation of gold particles can be accomplished.

2. A gold prospecting device as defined in claim 1, wherein: all accessories are stored inside said invention for storage and transportation. This is accomplished by a series of hinged sections that when rotated and compressed into storage mode allows for the implementation of closure lids. These lids allow for the storage of legs, mat, expanded metal, classifiers, riffles and etc. Device is then manually transportable by means of a carry handle or back straps, etc.

3. A gold prospecting device as defined in claim 1, wherein: Said invention has provisions for adjustments to the flow velocity of sand and gold slurry are adjusted by means of removable legs. The legs are adjustable and held in position by means of a retaining device. Upper tray is held in position by means of adjustable sliding braces, held in position by locking device. The steeper the angle of the device the faster the velocity of the slurry, therefore optimum velocity is obtained by pitch angle adjustment. If angle is too great the gold particles are washed through the device. If not great enough the slurry velocity is diminished and the eddies required to trap gold particles do not develop.

4. A gold prospecting device as defined in claim 1, wherein: said invention has the capability to be used in a recirculation water supply configuration. Whereby, water is stored in a containment vessel and pumped to the device for processing gold bearing materials. Upon completion of the separation process the water and sand slurry is returned to the containment vessel. Waste materials settle out of suspension and the water is available for reuse.

5. A gold prospecting device as defined in claim 1, wherein: Said invention has the capability to be used in a suction dredge configuration. Whereby, a slurry of gold bearing materials is dredged from a body of water and pumped to the device for processing. Aforementioned classifier removes larger waste for ejection and remaining slurry is processed as previously stated. When used in suction dredge configuration an external water supply is not needed as the slurry contains sufficient water for processing.

6. A gold prospecting device as defined in claim 1, wherein: Said inventions transportability is enhanced by the use of multiple folding sections. These sections hinge one upon the other thereby creating a multiple folding entity of normal width, and length when expanded, without sacrificing any gold recovering capabilities.

7. A gold prospecting device as defined in claim 1, wherein: Said inventions piping required for operation are permanent features of the device. No external piping or plumbing is required for operation with the exception of either a flexible water or suction dredge hose. Said piping is enhanced by the ability to remove caps at each end of the spray piping legs, thereby allowing for cleaning and debris removal.

8. A gold prospecting device as defined in claim 1, wherein Said inventions classifier 56, is interchangeable. Classifiers with different hole sizes are interchangeable thereby providing the prospector the option of selecting the maximum particle size to be allowed to enter the slurry stream. The closer the placer sand and gravel sizes are to the expected gold particle size the better the recovery rate.

9. A gold prospecting device as defined in claim 1, wherein: Said inventions capability to use different final mats 40 greatly enhances recovery chances. Choice to be at prospectors discretion as different situations dictate.

10. A gold prospecting device as defined in claim 1, wherein: Said inventions flexibility is greatly enhanced by use of optional water sources to include low voltage pump, gasoline pump, etc.

11. A gold prospecting device as defined in claim 1, wherein: Said inventions design allows for manufacture using numerous materials and assemblies. For example all attachments to lower tray 96 can be molded in one piece utilizing high strength plastic or other material. Possibilities also include welded parts instead of fasteners. This claim is not intended to limit possibilities of enhanced manufacturing methods.

12. A gold prospecting device as defined in claim 1, wherein: Said inventions design allows for use of different style riffling devices in lieu of those identified in the drawings and specifications.
